(19) United States
(12) Patent Application Publication
(10) Pub. No.: US 2009/0008318 A1
(43) Pub. Date: Jan. 8, 2009

(54) Modular Water Purification and Delivery System

(75) Inventors: John M. Anes, Napa, CA (US); Jeffrey Brian Godfrey, Fairfield, CA (US); Amanda A. Wise, Napa, CA (US); Michael A. Taylor, Napa, CA (US); Stephen E. Pazian, Homosassa, FL (US)

Correspondence Address: MILLER, MATTHIAS & HULL, ONE NORTH FRANKLIN STREET, SUITE 2350, CHICAGO, IL, 60606, US

(73) Assignee: PRISMEDICAL CORPORATION, American Canyon, CA (US)

(21) Appl. No.: 12/173,636

(22) Filed: Jul. 15, 2008

Related U.S. Application Data
(63) Continuation-in-part of application No. PCT/US07/86099, filed on Nov. 30, 2007.
(60) Provisional application No. 60/872,578, filed on Dec. 4, 2006.

(51) Int. Cl. C02F 1/42; C02F 9/00

(52) U.S. Cl. 210/262; 210/259; 210/287

(57) ABSTRACT

A modular filter system is provided with one or more modules that can be interchangeable, depending upon the specific application or specific health or environmental issue presented. Disclosed combinations can include one or more of any of the following modules in any relative position to one another: (a) a microbiological contaminant mitigation module, preferably in the form of an inverted u-shaped hollow fiber filter module wherein the fibers have ends potted on the downstream side and that consists essentially of hydrophilic fibers for water filtration with a small amount of hydrophobic fibers for venting of entrapped air; (b) a first chemical mitigation module, preferably in the form of an adsorption module comprising carbon or the combination of carbon and a deionization resin; and (c) a second chemical mitigation module, preferably in the form of a deionization resin module. Modules including a carbon bed or a resin bed may be equipped with a pair of hydrophobic foam bed restraints that apply opposing axial pressure to the bed in all operating conditions.

### CROSS REFERENCE TO RELATED APPLICATION

This is a continuation-in-part of PCT/US07/86099, filed on Nov. 30, 2007 (MPEP §201.11(a)), which claims priority to U.S. Provisional Patent Application Ser. No. 60/872,578, filed on Dec. 4, 2006.

### BACKGROUND

1. Technical Field

A portable, modular water filter is provided with one or more modules that can be interchangeable, depending upon the specific application and specific health or safety issue presented. The combination of modules may include a microbiological contaminant mitigation module preferably in the form of a hollow fiber filter module, a first chemical mitigation module preferably in the form of an adsorption module comprising carbon or the combination of carbon and a deionization resin, and a second chemical mitigation module preferably in the form of a deionization resin module. The adsorption and deionization resin modules preferably comprise hydrophobic bed restraints on opposing ends of the bed to compensate for purification bed volume changes thereby preventing channel formation in the beds by applying a consistent axial pressure on the bed. The assembled filter may present the modules in any relative position with respect to one another.

2. Description of the Related Art

In many places in the world, water must be treated in an economical and convenient manner for before it is suitable for drinking by people. In this regard, portable drinking devices are available that provide filtration of microorganisms from drinking water. However, currently available portable filtration devices are typically inadequate for the removal of protozoan cysts from water because the filter effective pore size is not sufficiently small. Further, currently available portable filtration devices also typically fail to filter small bacteria particles because of the pore size problem. Filtration media possessing the capability to filter cysts of 1 to 3 μm size and smaller bacteria particles are relatively dense, thereby inhibiting the flow of water through the media. As a result, such a portable filter device requires an excessive amount of strength to use and therefore many users are unwilling or unable to use these devices.

One approach to solving this problem is to provide a greater surface area by using the volume space which increases the effective filter area dramatically. One filter media that meets these criteria is hollow fiber membrane bundles. The large surface to volume ratio of the hollow fibers greatly increases the area available for contact with the water flowing through the bundle. But even with the application of hollow fiber membrane bundles, the pressure drop across a filter capable of being deployed as a portable bottle filter is substantial. Many currently available hollow fiber membrane filters provide a flow rate of only about 12 to 35 ml per second at an applied pressure of 10 psig. Any blockage or other restriction to the flow of water through the membrane bundle results in even slower flow rates, rendering the device unacceptable to many users.

Because the use of hollow fiber membrane bundles in portable filter applications may result in air accumulating within the bundle housing between uses, a large percentage of the squeezing pressure must be used to expel air from the filter. While the air is venting, the flow of water exiting the filter is lessened. It may take several minutes of continuous flow to fully purge the filter of air. Another problem that may be encountered if air is allowed back into the individual hollow fiber membranes, which may cause membrane blockage.

Other problems associated with hollow fiber membrane filters is with their use for the treating highly polluted water which can result in the hollow fibers cohering together into a mass upon which organic matter can accumulate. The effective membrane surface area of the hollow fibers is reduced causing a decrease in filtering flow rate. As a result, the hollow fiber membrane bundle must be periodically subjected to surface cleaning and/or back washing, which is not practical for a portable device in the field.

Further, portable water filtration or purification devices tend to be fixed in design, meaning that once in the field, they cannot be modified to meet the particular water quality problems encountered unless multiple purification systems are incorporated. Obviously, for portable devices used in the field, multiple devices would be unwieldy.

Thus, hollow fiber bundles alone are not entirely effective as a filter media. What is needed is a flexible system that can provide multiple filter media and that can be easily reconfigured to address the particular environmental issue present. Typically, the major concerns in connection with surface water encountered in the field are protozoal and parasitic cysts and bacteria. These are commonly addressed by size exclusion filters, but flow rate and pressure required remain a problem. Bacteria and viruses can also be mitigated with disinfectants. Cysts are more resistant to disinfectants, which require extended exposure times to be effective. Many other potential hazards likely to be present in available surface water are not addressed by filtration or disinfection. These include various chemical contaminants, such as: inorganic chemicals, including arsenic, cyanide and beryllium; organic chemicals, including pesticides, like aldrin, dieldrin, endrin and endosulfan; and biological toxins from bacteria and algae. In environmental disaster situations other man-made contaminants may be present such as solvents and gasoline derivatives. In many cases environmental conditions or man-made contamination may impart noxious tastes and odors that render water unpalatable.

Another potential requirement of personal or portable water purification is mitigation of nuclear biological and chemical warfare (NBC) agents in water. By addition of augmentation capability with dry reagents, it would be possible to produce nutritional or therapeutic fluids in remote settings.

To be effective against all categories of contaminants, filtration systems are needed that can be adapted or reconfigured with relative ease.

A conventional, prior art, ion-exchange resin module is identified by reference numeral 63 in FIG. 7. The resin module 63 has a fluid inlet 14a for introduction of the water in need of filtering. The filtered water exits the module 63 through a fluid outlet 29a. The module 63 contains a resin bed 21a. During the filtration process, undesirable ions (anions and cations) are retained in the resin bed 21a while harmless ions (anions and cations), such as chlorine, exit the fluid outlet 29a.

The resin 21a typically comprises a mixture of resins with strong anion exchanger (cation-impregnated) and strong cation exchanger (anion-impregnated) chemistries, binding dissociable ions and other charged particles with a very high affinity. Prior to use, the ion-exchange resin 21a is hydrated with a buffer solution to convert the resin from a powder to a slurry. To prevent the resin 21a slurry from passing through the fluid outlet 29a, and to prevent the resin powder from falling out the inlet 14a or outlet 29a during storage or prior to use, hard screens or “fits” 35 are positioned adjacent the fluid inlet 14a and fluid outlet 29a. See also FIG. 9. The screen 35a adjacent to the outlet 29a may also trap fine particles which result from degradation of the resin 21a.

The solid particles of the resin 21a are relatively fragile and swell or contract by osmotic action. It is highly desirable for all of the solution entering the fluid inlet 14a to fully contact the resin 21a before leaving the fluid outlet 29a. Therefore, the resin 21a is relatively tightly packed into the filtration module between the screens 35a to minimize the formation of voids and fluid channels in the reaction medium during operation of the ion-exchange column. As a consequence of this tight packing and the repeated expansion of the resin beads against the hard screen inserts 35a, the resin beads begin to fracture and form fine particles (“fines”). These “fines” are often trapped in the inserts 35a and do not exit the fluid outlet 29a. The outlet screen 35a may eventually become clogged with these fine particles diminishing the efficacy of the module 63 even though the resin 21a remains functional. In addition, undesirable voids such as head spaces 64 and channels 65 can be formed in the resin 21a when the resin 21a contracts as illustrated in FIG. 9.

U.S. Pat. No. 4,871,463 attempts to address this problem by providing a rigid manifold member with radial fins and a cellulosic membrane. However, this system still results in the fluid flow distribution irregularities illustrated in FIG. 7 and uneven axial pressure being applied to the resin bed. Specifically, the fluid tends to form a parabolic fluid distribution 66 and current eddies or vortices 67 disposed along the sidewall 41a as shown in FIG. 7. The flow distribution of FIG. 7 does not provide the desired uniform fluid flow across the cross-sectional area of the resin bed 21a. A uniform fluid flow is necessary to provide a uniform and maximum exposure for all of the fluid flowing through the bed 21a. In the parabolic flow distribution 66 shown in FIG. 7, the fluid on the outside of the parabolic distribution 66 has a longer travel path through the resin 21a and a greater period of exposure to the resin 21a than does fluid passing through the center of the distribution 66. In addition, the vortex-prone areas near the sidewall 41a receive little fluid flow.

Therefore, a need exists for filtration modules that promote and enhance uniform fluid flow across the entire cross section the resin and through the module.

### SUMMARY OF THE DISCLOSURE

In satisfaction of the aforenoted needs, a modular filter is provided with one or more modules that can be interchangeable, depending upon the specific application or specific health or environmental issue presented. Disclosed combinations can include any of the following modules in any relative position to one another:
(a) a microbiological contaminant mitigation module, preferably in the form of an inverted u-shaped hollow fiber filter module wherein the fibers have ends potted on the downstream side and that consists essentially of hydrophilic fibers for water filtration with a small amount of hydrophobic fibers for venting of entrapped air;
(b) a first chemical mitigation module, preferably in the form of an adsorption module comprising carbon or the combination of carbon and a deionization resin; and
(c) a second chemical mitigation module, preferably in the form of a deionization resin module.

For the chemical mitigation and deionization modules that include some form of a bed such as an activated carbon bed or a resin bed, the modules preferably include expandable and contractible bed restraints disposed on either side of the bed. In one refinement, the bed restraints are fabricated from porous hydrophobic material. In a further refinement of this concept, the restraints are fabricated from a hydrophobic foam material. The hydrophobic foam material applies consistent axial pressure to the bed in both directions regardless of the state of the expansion or contraction of the bed and acts to optimize water flow through the bed without the need for a manifold device.

In a refinement, the hydrophobic foam bed restraints are used with any one of a myriad of ion exchange resins, activated granular carbons, KDF®, TRIOSYN®, and combinations of these and other purification materials. Preferably, the bed restraints are fabricated from hydrophobic polyurethane, with thicknesses ranging from about 0.125 to about 0.5 inches and from about 40 to about 120 pores per inch (PPI). One preferred embodiment includes 0.25″ thick hydrophobic polyurethane foam with 80 PPI, but variations will be apparent to those skilled in the art.

It is been surprisingly found that the hydrophobicity of the foam bed restraints forces distribution of the fluid flow to the periphery of the housing interior before entering the purification bed, thereby substantially flattening or eliminating the parabolic fluid flow profile of prior art devices, which results in maximization of the purification capacity of the module. It is also been surprisingly found that the hydrophobic foam bed restraints also change in volume or thickness inversely to the changes in volume of the purification bed to compensate for purification bed volume changes which prevents channel formation by a consistently applying axial pressure in both directions to the purification bed.

The modular configuration provides dynamic capabilities within a single system that enables field modification and cleaning of the system to meet the purification requirements of a given situation. Modification of the system enables mitigation of all categories of contaminants likely to be encountered.

One disclosed system comprises a prefiltration module, an anti-microbial and particulate module, an inorganic chemical agent module, an organic chemical agent module, and a noxious taste and odor module. The modules are capable of mitigation of different categories of contaminants or can function synergistically to address various categories of contaminants. The interconnections may be either reciprocal threaded connections or other types of universal interconnection, thereby enabling interconnection of any modules in any sequence or interconnection of multiple redundant modules to mitigate very high levels of specific contaminants, such as heavy metals during chemical warfare agent contaminated environment.

In a refinement, the modules may include external connections such as hose barbs, o-ring based snap quick-disconnects or other sterile connections.

A prefilter, if used, is preferably detachable and employed upstream of a first or primary filter module regardless of whether the primary module is a hollow fiber, carbon or the ionizing resin filter. The prefilter may consist of a single mesh sieve, a series of progressively tighter mesh sieves or a progressively tighter porosity depth filter as flat stock, pleated or spiral wound configurations. The prefilter serves to retain larger particulates such as biological and inorganic debris, preventing clogging of downstream modules. The pre-filter has a mesh size ranging from 20 to about 120 μm, more preferably from about 50 to about 90 μm, still more preferably from about 65 to about 75 μm.

By way of example, the first module or primary water filter module may include looped hollow fibers with potted ends. Both ends of the fibers are potted at the outlet end of the module. The inverted u-shaped looped portion of the fibers is directed towards the inlet end of the module or towards the pre-filter. Two types of hollow fibers are utilized. About 99% of the fibers are hydrophilic in use for water filtration and about 1% of the fibers is hydrophobic and is used to release entrapped air from the chamber that accommodates the hollow fibers. The hydrophilic fibers have a pore size ranging out of 0.005 to about 0.4 μm, more preferably from about 0.02 to about 0.22 μl, still more preferably from about 0.2 to about 0.1 μm. The hydrophilic fibers are preferably fabricated from polysulfone, polyethersulfone or an equivalent. The hydrophobic fibers are preferably made from polypropylene or an equivalent.

A second module may be a chemical adsorption module comprising granulated carbon, granulated carbon treated with a deionization resin, a combination of granular carbon and deionization resin or a suitable equivalent. In one embodiment, the organic filtration stage comprises a resin bed treated for retention of organic contaminants and commonly used additives in municipally-treated water.

A third module may a deionization stage, comprising a bed of deionization resin beads. The resin bed preferably comprises a mixture of pharmaceutical grade resins with strong anion exchanger (cation-impregnated) and strong cation exchanger (anion-impregnated) chemistries, binding dissociable ions and other charged particles with a very high affinity. In an embodiment, the deionization resin bed comprises mixed anion- and cation-impregnated resin beads with weakly associated hydrogen or hydroxyl groups, respectively. The skilled artisan will recognize other types of ion-exchange resins that could also be utilized in this stage.

A female-female threaded adapter may be employed which allows the downstream module to be connected to a collapsible water bottle or collapsible sport bottle. Such a female-female threaded adapter would connect the downstream module, with a 40 mm fitting to a conventional sports bottle, such as one having a 20 mm fitting.

In a refinement, a three module system includes a first or upstream carbon filtration stage, a middle deionization resin stage and a final hollow fiber stage. Preferably, a pre-filter is used between the carbon stage and the inlet.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is an elevation or view of a modular filtration system made in accordance with this disclosure;

FIG. 2 is an exploded view of the filtration system shown in FIG. 1;

FIG. 3 is an elevational view of yet another modular filtration system made in accordance with this disclosure;

FIG. 4 is a sectional view of the filtration system shown in FIG. 3;

FIG. 5 is an exploded view of yet another modular filtration system made in accordance with this disclosure;

FIG. 6 is a partial exploded view of a female-female adapter used to attach a downstream module to a water bottle such as a sports bottle;

FIG. 7 schematically illustrates a fluid flow pattern through a prior art resin bed-type filtration module;

FIG. 8 schematically illustrates the employment of expandable and contractible bed restraints above and below a resin bed white still employing a conventional rigid screen above and below the resin bed;

FIG. 9 schematically illustrates the formation of voids or headspace areas and channels in a conventional prior art resin bed filtration module, such as the module shown in FIG. 7;

FIG. 10 schematically illustrates the uniform upward and downward axial pressure imposed on a resin bed by upper and lower foam restraints shown schematically in contracted and expanded states; and

FIG. 11 illustrates a resin bed-type filtration module employing the foam restraints disclosed herein which provide the uniform fluid flow across the bed as illustrated.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

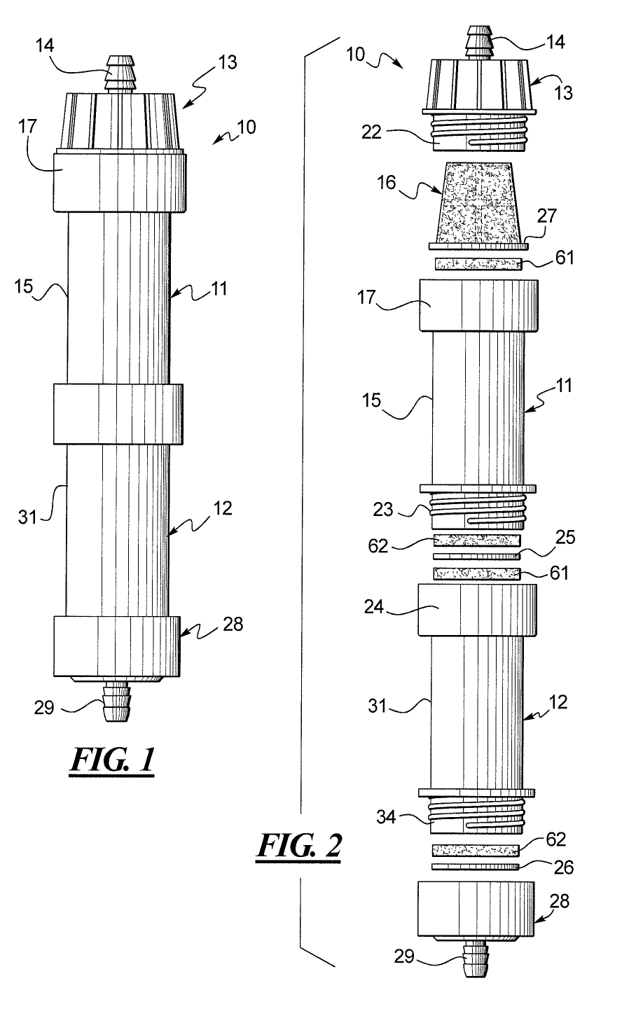

A filtration system 10 with dual modules 11, 12 is illustrated in FIG. 1. The system 10 includes an inlet housing 13 which features a barbed inlet 14 for connection to a flexible water supply line (not shown). The inlet housing 13 serves as an end cap which is threadably connected to the housing 15 of the first module 11 as illustrated in FIG. 2. Referring to FIGS. 1 and 2 together, in a preferred embodiment, a prefilter element 16 is utilized to retain larger particles upstream of the first module 11. A prefilter 16, if used, is preferably employed upstream of a first or primary filter module 11 regardless of whether the primary module 11 is a hollow fiber, carbon or the ionizing resin filter. The prefilter 16 may consist of a single mesh sieve, a series of progressively tighter mesh sieves or a progressively tighter porosity depth filter as flat stock, pleated or spiral wound configurations. The prefilter 16 serves to retain larger particulates such as biological and inorganic debris, preventing clogging of downstream modules. Use of progressive porosity mesh sieves with extended lateral faces provides a means of self-cleaning due to the tangential flow across the vertical surface of the mesh. Construction of the framework of the prefilter from elastomeric materials enables the base 27 of the prefilter 16 to serve as a gasket between the inlet housing 13 and the inlet 17 of the module housing 15.

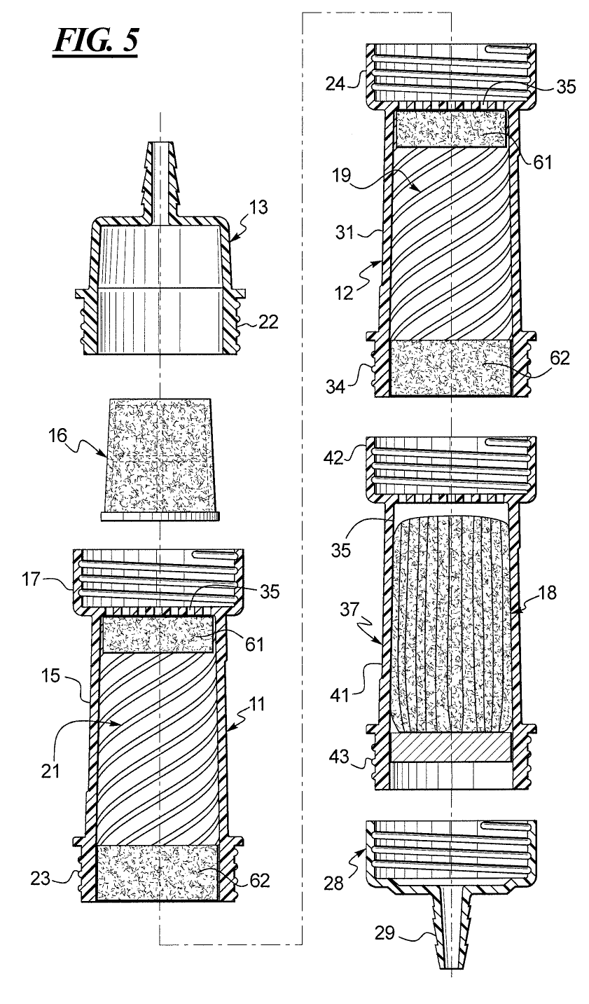

The module 11 of FIG. 1 accommodates an additional filter element such as a hollow fiber bundle 18, an deionization filtration stage 19 or a organic filtration stage 21 (see FIGS. 4 and 5). Returning to FIGS. 1 and 2, the housing 15 of module 11 includes the female threaded element 17 which receives the male threaded element 22 of the inlet housing 13. Consequently, the housing 15 also includes a male threaded element 23 which is threadably received in the female threaded element 24 of the housing 31 of the succeeding module 12. Gaskets 25, 26 can be utilized for sealing purposes. As noted above, the pre-filter mesh 16 may also be equipped with the gasket 27 thereby eliminating the need for separate gasket between the housing 13 and housing 15. The end housing 28 includes a female threaded element 33 (not shown FIG. 2, see FIG. 4) that threadably engages the male threaded element 34 of the housing 31 as well as a hose barb 29.

The dual module system 10 shown in FIGS. 1 and 2 will preferably employ two or more filtration stages in addition to the pre-filter screen 16. The additional filtration stages disposed in the housings 15, 31 of the modules 11, 12 may be in the form of a hollow fiber bundle 18 (FIG. 5) and one or both of an organic filtration stage 21 and deionization stage 19. The deionization filtration stage 19 and organic filtration stage 21 preferably employ upper and lower hydrophobic foam restraints 61, 62 as illustrated in FIGS. 2-5.

For the chemical mitigation, organic filtration and deionization modules 11, 12 that include some form of a bed such as an activated carbon bed or a resin bed, the modules 11, 12 preferably include bed restraints 61, 62 disposed on either side of the bed. Preferably, the bed restraints 61, 62 are fabricated from porous hydrophobic material. In a refinement the restraints 61, 62 are fabricated from a hydrophobic foam material. The hydrophobic foam material applies axial pressure to the beds 19, 21 in both directions and acts to optimize water flow over the purification bed without any need for a manifold device.

In a refinement, the hydrophobic foam bed restraints 61, 62 are used with any one of a myriad of ion exchange resins, activated granular carbons, KDF®, TRIOSYN®, and combinations of other purification materials. Preferably, the bed restraints 61, 62 are fabricated from hydrophobic polyurethane, with thicknesses ranging from about 0.125 to about 0.5 inches, more preferably about 0.25 inches and from about 40 to about 120 pores per inch (PPI), more preferably about 80 PPI. Such a suitable foam along with other suitable foams are available from New England Foam Products, LLC, P.O. Box 583, Windsor, Conn. 06905. The scope of this disclosure is not limited to hydrophobic polyurethane foams.

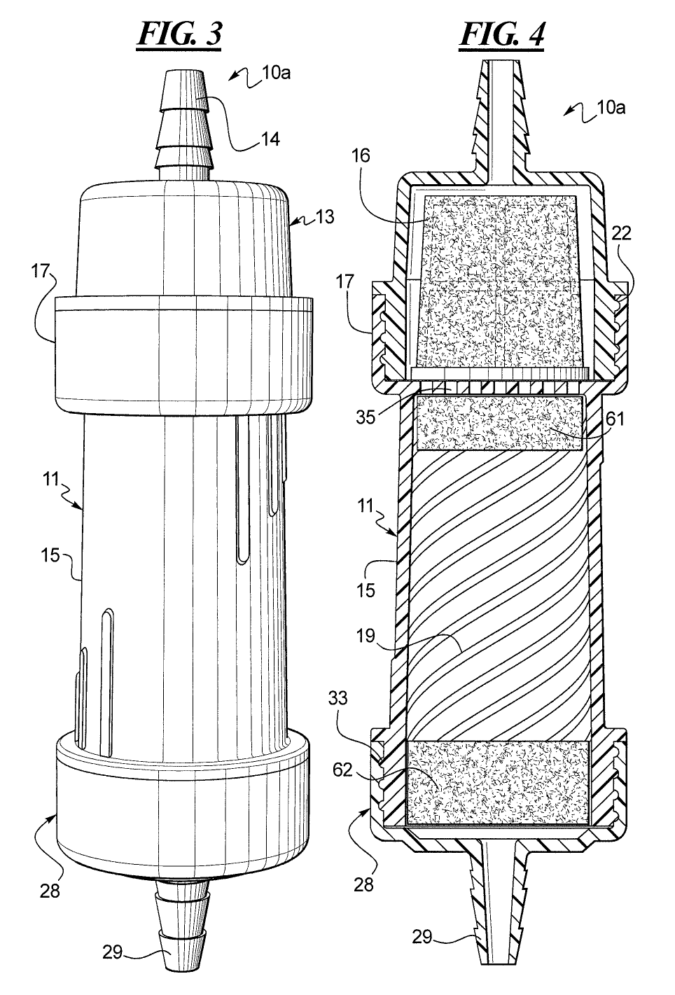

The filtration system 10a shown in FIGS. 3 and 4 can accommodate at least two filter elements including a pre-filter 16 and a deionization filtration stage 19 as shown in FIG. 4 and/or a hollow fiber bundle 18 (not shown in FIG. 4, see FIG. 5) and/or an organic filtration stage 21 (not shown in FIG. 4, see FIG. 5). Further, more than one type of filtration stage may be accommodated in any given module 11, 12, 37. That is, an organic filtration stage or bed 19 and deionization stage or bed 21 may be accommodated in a single module housing 15 (or 31 or 41) or either of these types of stages may be combined with a hollow fiber bundle stage in one module housings 15 (or 31 or 41). Preferably, if a hollow fiber bundle 18 is used, the fiber stage 18 should be used at the last stage or end stage immediately upstream of the outlet 29 so that larger particles and organisms are removed upstream by the pre-filter 16, organic stage 21 and deionization stage 19. Any of the housings may be equipped with a restraint element or screen 35 as seen in FIG. 4 that can be used to separate different types of filter stages from one another.

Turning to FIG. 5, a three module system is disclosed that includes three modules 11, 12, 37 for accommodating various combinations of filter stages. In the specific example shown in FIG. 5, the stainless steel mesh pre-filter stage 16 is followed by an activated granular carbon stage 11 which is followed by a deionization stage 12 that is followed by a hollow fiber membrane filter stage 18. The activated granular carbon stage 11, deionization stage 12, or hollow fiber membrane filter stage 18 can be presented in any order and stages may be repeated or duplicated as a water treatment train, depending upon the hazards present. The preferred embodiment is to have hollow fiber membrane filter stage 18 last in order to ensure microbiologically safe water. If a pre-filter 16 is used, the pre-filter 16 should be disposed in the inlet housing 13.

The organic or chemical adsorption stage 21 preferably comprises granulated carbon or granulated carbon and deionization resin. In one embodiment, the organic filtration stage comprises a resin bed treated for retention of organic contaminants. The illustrated embodiment incorporates a form of sulfonated polystyrene cross-linked with divinylbenzene commercially available from Rohm & Haas of Philadelphia, Pa., USA under the trade names Ambersorb 563. Ambersorb 563 removes certain residual organic contaminants, such as endotoxins, as well as commonly used additives placed in municipally treated waters (e.g., chlorine, trihalomethanes and chloramine).

The deionization stages 19 preferably comprise a bed of deionization resin beads. The resin bed preferably comprises a mixture of pharmaceutical grade resins with strong anion exchanger (cation-impregnated) and strong cation exchanger (anion-impregnated) chemistries, binding dissociable ions and other charged particles with a very high affinity. In an embodiment, the deionization resin bed comprises mixed anion- and cation-impregnated resin beads with weakly associated hydrogen or hydroxyl groups, respectively. The ion exchange resins of the preferred embodiment comprise styrene divinyl benzene. Such resins are available, for example, from Rohm & Haas of Philadelphia, Pa. under the trade name IRN 150, or from Sybron of Birmingham, N.J. under the trade name NM60. Cation exchangers exchange hydrogen atoms for any dissolved cations in the diluent. Common dissolved cations include sodium (Na⁺), calcium (Ca²⁺) and aluminum (Al³⁺). The anion exchange resins exchange hydroxyl ions for any anions present in an aqueous solution. Common anions include chloride (Cl⁻) and sulfides (S²⁻). The resin bed 32 additionally retains some endotoxins that escape the upstream filtration components. The skilled artisan will recognize other types of ion-exchange resins that could also be utilized in this stage.

Thus, each uniform module 11, 12, 37 includes a housing 15, 31, 41 with an inlet or proximal end 17, 24, 42, a cylindrical housing body 15, 31, 41 and an outlet or distal end 23, 34, 43. The preferred configuration is a cylinder. The proximal and distal ends consist of reciprocal male 23, 34, 43 and female 17, 24, 42 threaded fittings that allow easy and fast interconnection of modules.

These module housings 15, 31, 41 are preferably at or less than 12 inches in diameter by 18 inches in height, more preferably they are at or less than 6 inches in diameter and 6 to 12 inches in height and more preferably ½ to 3 inches in diameter and 2 to 4 inches in height. The contents of the modules 11, 12, 37 contain filtration components to mitigate all categories of contaminants likely to be encountered in source waters.

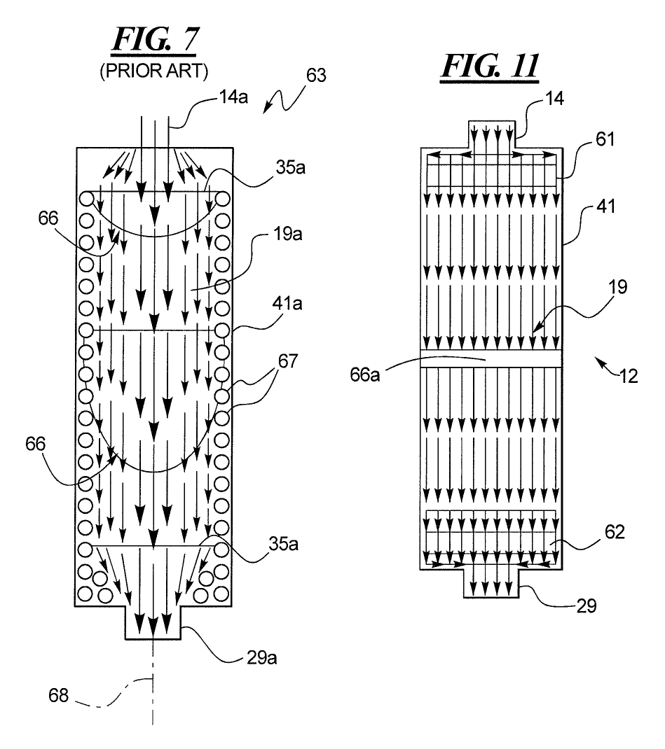

Turning to FIGS. 7-11, the advantages of the hydrophobic foam bed restraints 61, 62 are illustrated. FIG. 7 illustrates a prior art module 63 without foam bed restraints. Despite the use of tipper and lower screens 35a and perhaps a manifold structure, the majority of the fluid flows downward through the axial center 68 of the module 63 resulting in the parabolic fluid profiles shown at 66. A portion of the bed 19a disposed nearest the sidewall 41a experiences little fluid flow and is prone to the formation of vortexes or eddies 67. While prior art solutions including combinations of fibrous materials and manifolds have been tried in the past, a unique and simple solution has been found in the form of hydrophobic foam membranes shown at 61, 62 in FIGS. 2-5 and 8-11.

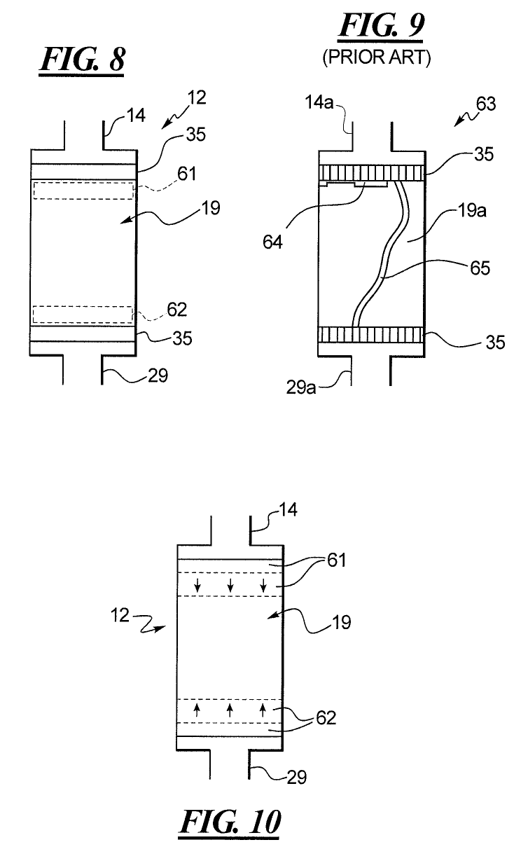

As shown in FIG. 8, a module 12 may be constructed with upper and lower screens 35 in combination with upper and lower foam bed restraints 61, 62. As shown in FIG. 10, the module 12 may be constructed without the rigid screen filters 35 and only the upper or lower foam restraints 61. FIG. 10 also illustrates the expansion of the foam restraints 61, 62 from a thinner contracted position to a thicker expanded condition. The hydrophobic foam restraints 61, 62 apply uniform axial pressure to the bed 19 which produces the uniform fluid flow illustrated schematically in FIG. 11. As opposed to the parabolic profile 66 is shown in FIG. 7, the disclosed modules 11, 12, 37 provide a flat fluid flow profile shown at 66a in FIG. 11, while avoiding the formation of voids 64, head spaces 64 and channels 65 shown schematically in the prior art module of FIG. 9.

As shown in FIG. 11, it has been surprisingly found that the hydrophobicity of the hydrophobic polyurethane foam bed restraints 61, 62 forces distribution of the fluid flow to the periphery of the housing 41 interior before entering the purification bed 19 (or 21), thereby flattening fluid flow profile 66a, which results in maximization of the purification capacity of the module. It has also been surprisingly found that the hydrophobic foam bed restraints 61, 62 also change in volume or thickness inversely to the changes in volume of the purification bed 19 (or 21) to compensate for purification bed 19 (or 21) volume changes, which prevents formation of channels 65 (see, e.g., FIG. 9) by applying consistent axial pressure in both directions to the purification bed 19 (or 21).

The hollow fiber bundle module 18 is used for microbiological contaminant filtering. Other filters may be used instead of hollow fibers. A suitable microfilter is preferably used to retain protozoal and parasitic cysts, bacteria, other potentially toxic environmental toxin such as algae and particulates. Because most radionuclear contaminants have a tendency to bind particulates, this module can also provide effective mitigation of these contaminants. Use of 0.02 micron or smaller pore size micro-filters in this module also mitigates virus, aggregated bacterial toxins and larger molecular weight environmental toxins. If a hollow fiber bundle is not used, a substitute microfiler can be configured as a single flat filter, pleated filter, spiral wound filter or hollow fiber. All configurations should be attached to the module housing to assure an integral seal of the filter to the housing. Alternative materials may be incorporated to facilitate venting such as hydrophobic materials such as PTFE, polypropylene or polyethylene.

Enhanced anti-microbial activity can be incorporated into the system through use of disinfectants in the source water bag or inclusion of antimicrobial agents within modules. These agents could include immobilized halogens, iodinated or brominated resins, and silver impregnated carbons or resins or combinations of these agents.

The chemical mitigation stages 19, 21 can contain adsorptive agents such as carbon or synthetic carbon-like agents, deionization resins, selective affinity agents or combinations of these agents. These agents can be contained within porous or mesh restraints 35, porous enclosures or as free particles. These modules are effective for mitigation by retention of organic chemicals, such as pesticides, herbicides, insecticides, solvents, gasoline degradation products. It is also effective at mitigation by retention of inorganic chemicals, such as heavy metals and dissociable salts.

Additional chemical mitigation utilizes a non-woven material wrap impregnated with either carbon and/or deionization resin. This wrap is located around the hollow fiber bundles serving to cushion the bundle from shock while enhancing the chemical mitigation capacity.

Weak acid deionizer containing modules can preferentially retain heavy metals; ferrous agents can retain arsenic and cyanide. Combinations of carbon and resin within modules are more efficient for mitigation of offensive odors and tastes.

External connections include fitments that match the module housing inlets 17, 24, 42 and outlets 23, 34, 43. In addition to the threaded connections shown, the opposing ends of these fitments can be hose barb fittings, bayonet fittings, Luer fittings or o-ring based snap quick-disconnect fittings.

For static (stationary) use, the inlet housing or initial module 13 attaches to a reciprocal male or female fitment incorporated into a source water reservoir bag. This bag can contain a means of reversible opening to allow filling and closure. These types of closures can include, but are not limited to single and double zip-lock fitments, hook and loop fasteners, pinch clip closures, roller closures, other lock and key fittings.

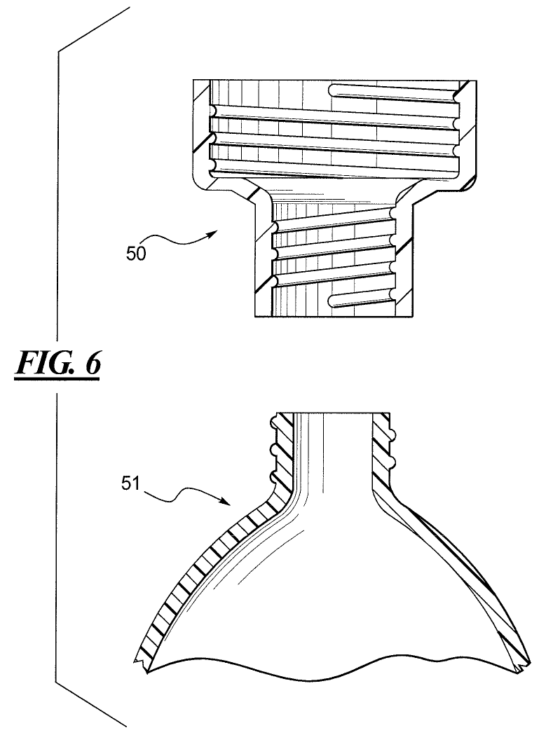

Product water can be collected in a clean water bag or any desired receptacle. Use of a non-elastic or minimally elastic polymer for the clean water bag enables the bag to be a self-limiting flow control. FIG. 6 illustrates a female-female adapter 50 that can be used to connect male threads 23, 34, 43 of a downstream module 11, 12, 37 to a water bottle or sports bottle 51. Typically, the modules 11, 12, 37 are 40 mm wide and a conventional sports bottle 51 is 26 mm wide. Wide-mouth sports bottles are also known and therefore a 40 mm-40 mm female-female adapter or other suitably sized adapter may also be required in such a situation.

Through the use of modular contaminant specific components all categories of contaminants can be mitigated. This option can include use of redundant modules that can be used to mitigate the elevated contaminants levels associated with man-made disasters or extraordinary natural occurrences. In this manner, rehydration in contaminated settings can be accomplished using available source water that may be contaminated highly toxic chemical or biological agents without having to extricate from the setting, decontaminate, rehydrate, re-robe in hazard material protective garments and re-enter the contaminated setting. Additionally replacement of spent modules does not require replacement of the remaining still functional portions of the system.

Augmentation or addition of reagents to the product water to produce solutions rather than water can be achieved by addition of reagent to the filtration module 11, 12, 37 or to the collection bag. Maintenance of sterility the prepared solution would require reagent placement in the filtration modules 11, 12, 37 enabling filter sterilization as the solution passes through the filter system. For sterile solutions, where reagents are added to the collection bag, the reagents must be pre-sterilized.

For mobile use, the disclosed modules terminal interconnects can be connected to a bite tube or hazardous materials mask or protective suits. Heavily silted waters particulate load can be mitigated with multiple prefilters of progressively tighter pore mesh to retrain larger contaminants without clogging the subsequent filtration module. Brackish water dissociable ions can be mitigated with multiple deionization filter modules. Noxious taste and smells can be mitigated with redundant carbon containing modules. Addition of power to the system can enable incorporation of propulsion mechanisms, indicators for flow or flow control and sensors. Power supplies can be derived from self-contained electrical power sources such as batteries; external electrical power from grid sources, solar or power generators; mechanical power generation via spring actuated components or hand pumping; or other external power sources. Propulsion mechanisms include, but are not limited to, pumping or vacuum components. Indicators could include, but are not limited to, flow volume measurement or flow rate measurement. Control mechanisms could include, but are not limited to, shut-off valves or pressure reduction mechanisms. Sensors could include, but are not limited to: ion measurement, to identify the concentration of dissolved solids; specific ion concentration, to identify selective ion concentrations; biological or organic carbon measurement, to identify the presence or concentration of organic chemicals, biologicals, bacteria or virus; and pH measurement.

Pretreatment of source water within the water reservoir can enhance system purification capabilities. Use of flocculants can induce aggregation of particulates, which when matched with a mesh prefilter can prevent subsequent clogging of downstream modules.

Torturous path extension of the path of flow within a chemical purification module can be achieved by spiral flow through the purification bed. The spiral flow can be achieved with conveyer screw insert within the module directing flow laterally rather than axially. In this manner the time of contact and length of exposure to the purification bed can be roughly doubled within the same height module housing.

The female threaded interconnects on the inlet of modules can thread directly onto a source water bag with a male threaded terminal fitment that is the reciprocal of the inlet. Alternately, a male threaded outlet of a module can be threaded on a female threaded inlet fitment on a collection bag or other means of collection. Alternatively male by male or female by female threaded or bayonet inserts can be used to interconnect modules with reciprocal interconnects or other fitments with reciprocal, terminal interconnects, such as source water bags or collection bags. A male threaded fitment on a source water bag could be attached to a male threaded module attachment via a female by female threaded interim fitting. Inversely, a female threaded fitment could be attached to a female threaded module fitting via a male by male threaded fitting.

An alternative means of containment of purification beds or contained filtration mechanisms is enclosure of these subcomponents into cartridges or soft-sided pouches that allow interchange of purification components or filter components within modules. Augmentation of purified fluids with dissolution of dry soluble agents from modules containing these reagents to produce nutritional or therapeutic fluids in remote settings.

Again, the various modules are interconnectable by reciprocal interconnects that enable stacking of multiple modules. Each module may contain different functional capabilities to accomplish any form or level of contaminant mitigation that could be required. The terminal interconnects enable the modules to be used to form either static or portable systems. For static use, the terminal connection can be attached to a source water reservoir to provide head pressure to drive flow. For mobile use, the terminal interconnects allow insertion of the system between a source water bladder and a bite tube.

The ability to easily connect and disconnect module housings enables the specific modules to be changed as well as the order in which the modules are employed to be changed. For example, in certain applications it is desirable to filter the water first with a carbon filter and/or a deionizer resin prior to exposing the hollow fiber bundle to the water. In other applications, it is desirable to filter the water with a hollow fiber bundle first. The modularity of the disclosed filter systems enables the filter to be custom-designed for each application.

While only certain embodiments have been set forth, alternatives and modifications will be apparent from the above description to those skilled in the art. These and other alternatives are considered equivalents and within the spirit and scope of this disclosure and the appended claims.

1. A modular water filtration system comprising:
an inlet connected to and disposed between a water source and a first module housing, the first module housing disposed between the inlet and a second module housing, the second module housing being disposed between the first module housing and an outlet for the passage of filtered water,
the first module housing accommodating a first filtration stage, the second module housing accommodating a second filtration stage, the first and second filtration stages being selected from the group consisting of a hollow fiber bundle, a bed of granular carbon, a bed of granular carbon treated with styrene divinylbenzene, a bed of granular carbon and deionization resin and a bed styrene divinylbenzene beads,
at least one of the first and second filtration stages comprising a bed of filtration material selected from the group consisting of granular carbon, a granular carbon treated with styrene divinylbenzene, a bed of granular carbon and deionization resin and divinylbenzene beads, and
wherein said bed is sandwiched between a pair hydrophobic foam bed restraints, the bed restraints applying axial pressure in opposing directions to the bed.

2. The system of claim 1 further comprising a pre-filter mesh disposed between the inlet and the first filtration stage, the pre-filter mesh having a pore size ranging from about 40 μm to about 100 μm.

3. The system of claim 1 further comprising a third module housing disposed between the second module housing and the outlet, the third module housing accommodating a third filtration stage that is selected from the group consisting of a hollow fiber bundle, a bed of granular carbon, a bed of granular carbon treated with styrene divinylbenzene, a bed of granular carbon and deionization resin and a bed styrene divinylbenzene beads.

4. The system of claim 3 wherein, if the third filtration stage comprises a bed of granular carbon, granular carbon treated with styrene divinylbenzene, or styrene divinylbenzene beads, the third filtration stage is sandwiched between two hydrophobic foam bed restraints disposed in the third module housing, the bed restraints applying axial pressure in opposing directions to the third filtration stage.

5. The system of claim 3 wherein the third filtration stage comprises a hollow fiber bundle.

6. The system of claim 4 further comprising a fourth filtration stage disposed between the inlet and outlet, the fourth filtration stage selected from the group consisting of a hollow fiber bundle, a bed of granular carbon, a bed of granular carbon treated with styrene divinylbenzene, a bed of granular carbon and deionization resin and a bed styrene divinylbenzene beads.

7. The system of claim 6 wherein if the fourth filtration stage is one of a bed of granular carbon, granular carbon treated with styrene divinylbenzene, or styrene divinylbenzene beads, the fourth filtration stage is sandwiched between two hydrophobic foam bed restraints, the bed restraints applying axial pressure in opposing directions to the fourth filtration stage.

8. The system of claim 1 wherein at least one of the filtration stages comprises a hollow fiber bundle comprising hydrophilic fibers and hydrophobic fibers.

9. The system of claim 8 wherein the hydrophilic fibers have a pore size ranging from about 0.005 to about 0.4 μm.

10. The system of claim 9 wherein the hydrophilic fibers are fabricated one of polysulfone or polyethersulfone and the hydrophobic fibers are fabricated from polypropylene or an equivalent.

11. The system of claim 1 wherein at least one of the filtration stages comprises at least one anti-microbial agent selected from the group consisting of immobilized halogens, iodinated resins brominated resins, silver impregnated carbon, silver impregnated resin, and combinations thereof.

12. The system of claim 1 wherein the hydrophobic foam bed restraints comprise polyurethane foam.

13. The system of claim 12 wherein the bed restraints have pore densities ranging from about 40 to about 120 pore per inch (PPI).

14. The system of claim 13 wherein the bed restraints have thicknesses ranging from about 0.125 to about 0.5 inches.

15. The system of claim 14 wherein the PPI of the bed restraints ranges from about 60 to about 100 and the thicknesses range from about 0.2 to about 0.4 inches.

16. A modular water filtration system comprising:
an inlet connected to and disposed between a water source and a first module housing, the first module housing disposed between the inlet and an outlet for the passage of filtered water,
the first module housing accommodating a first filtration stage selected from the group consisting of a bed of granular carbon, a bed of granular carbon treated with styrene divinylbenzene, a bed of granular carbon and deionization resin and a bed styrene divinylbenzene beads,
wherein said bed is sandwiched between a pair hydrophobic foam bed restraints, the bed restraints applying axial pressure in opposing directions to the bed.

17. A modular water filtration system comprising:
an inlet connected to and disposed between a water source and a first module housing,
the first module housing disposed between the inlet and a second module housing, the second module housing disposed between the first module housing and a third module housing, the third module housing disposed between the second module housing and an outlet for the passage of filtered water,
the first module housing accommodating a first filtration stage, the second module housing accommodating a second filtration stage, the third module housing accommodating a third filtration stage,
the first and second filtration stages each being selected from the group consisting of a bed of granular carbon, a bed of granular carbon treated with styrene divinylbenzene, a bed of granular carbon and deionization resin and a bed styrene divinylbenzene beads,
the beds of the first and second filtration stages each being sandwiched between a pair hydrophobic foam bed restraints, the pairs of bed restraints applying axial pressure in opposing directions to the beds of the first and second filtration stages,
the third filtration stage comprising a hollow fiber bundle.

18. The system of claim 17 further comprising a pre-filter mesh disposed between the inlet and first filtration stage.

19. The system of claim 17 wherein the hollow fiber bundle comprises hydrophilic fibers and hydrophobic fibers, the hydrophilic fibers having a pore size ranging from about 0.005 to about 0.4 μm, the hydrophilic fibers being fabricated one of polysulfone or polyethersulfone and the hydrophobic fibers being fabricated from polypropylene or an equivalent.

20. The system of claim 19 wherein the hydrophobic foam bed restraints comprise polyurethane foam having pore densities ranging from about 40 to about 120 pore per inch (PPI) and thicknesses ranging from about 0.125 to about 0.5 inches.
